(19) United States
(12) Patent Application Publication
(10) Pub. No.: US 2021/0218052 A1
(43) Pub. Date: Jul. 15, 2021

(54) THREAD BATTERY

(71) Applicant: Murata Manufacturing Co., Ltd., Nagaokakyo-shi (JP)

(72) Inventors: Kou Tanaka, Nagaokakyo-shi (JP); Masahiko Kondo, Nagaokakyo-shi (JP); Makoto Yoshioka, Nagaokakyo-shi (JP); Yukio Ehara, Nagaokakyo-shi (JP)

(21) Appl. No.: 17/212,634

(22) Filed: Mar. 25, 2021

Related U.S. Application Data
(63) Continuation of application No. PCT/JP2019/037298, filed on Sep. 24, 2019.

(30) Foreign Application Priority Data
Sep. 27, 2018 (JP) 2018-182470

(51) Int. Cl. H01M 10/058; H01M 10/02; H01M 10/0562; H01M 4/62; H01M 4/48

(52) U.S. Cl. CPC H01M 10/058; H01M 10/02; H01M 2300/0071; H01M 4/62; H01M 4/483; H01M 10/0562

(57) ABSTRACT

A thread battery that includes: a thread-like first electrode that extends in a longitudinal direction between a first end and a second end that face each other in the longitudinal direction; a solid electrolyte on an outer peripheral surface of the first electrode; a second electrode on an outer peripheral surface of the solid electrolyte; a first current collector covering the first end, connected to the thread-like first electrode, and not connected to the second electrode; and a second current collector covering the second end, connected to the second electrode, and not connected to the first electrode.

### CROSS REFERENCE TO RELATED APPLICATIONS

The present application is a continuation of International application No. PCT/JP2019/037298, filed Sep. 24, 2019, which claims priority to Japanese Patent Application No. 2018-182470, filed Sep. 27, 2018, the entire contents of each of which are incorporated herein by reference.

### FIELD OF THE INVENTION

The present invention relates to a thread battery.

### BACKGROUND OF THE INVENTION

In recent years, as electronic devices have become smaller and thinner, the shape of a battery for power supply has been demanded to follow this smaller and thinner storage space.

Examples of a shape that easily follows the shape of the storage space include that of a thread-type battery as described in Patent Document 1. Patent Document 1 discloses a thread-type battery transformable into a variety of shapes. This thread-type battery includes: an internal electrode composed of an internal current collector and a negative electrode material coated on a peripheral surface of the internal current collector; an electrolyte installed outside the internal electrode; a positive electrode material coated on a peripheral surface of the electrolyte; and an external current collector and a protective coating portion which are provided on a peripheral surface of the positive electrode material.

Patent Document 1: Japanese Patent No. 4971139

### SUMMARY OF THE INVENTION

However, Patent Document 1 does not disclose any specific method for drawing a current from the thread-type battery to the outside. Since a required voltage differs for each electronic device, a plurality of batteries mounted on the electronic device are usually used in combination so as to obtain an appropriate voltage. However, in the thread-type battery described in Patent Document 1, not only the method for drawing a current to the outside but also a method for connecting the batteries to one another is unknown. Therefore, there has been a problem that voltage design cannot be freely performed when the plurality of batteries are used in combination.

The present invention has been made in order to solve the above problem, and an object of the present invention is to provide a thread battery that is easy to draw a current therefrom to the outside and has a high degree of freedom in voltage design.

A thread battery of the present invention is a thread battery that includes: a thread-like first electrode that extends in a longitudinal direction between a first end and a second end that face each other in the longitudinal direction; a solid electrolyte on an outer peripheral surface of the first electrode; a second electrode on an outer peripheral surface of the solid electrolyte; a first current collector covering the first end, connected to the thread-like first electrode, and not connected to the second electrode; and a second current collector covering the second end, connected to the second electrode, and not connected to the first electrode.

According to the present invention, the thread battery that is easy to draw a current therefrom to the outside and has a high degree of freedom in voltage design can be provided.

### BRIEF EXPLANATION OF THE DRAWINGS

FIG. 1 is a perspective view schematically illustrating an example of a thread battery of the present invention.

FIG. 2 is a sectional view taken along a line A-A in FIG. 1.

FIG. 3 is a sectional view taken along a line B-B in FIG. 1.

FIGS. 4(a) to 4(f) are schematic views illustrating an example of a method for manufacturing the thread battery of the present invention.

### DETAILED DESCRIPTION OF THE INVENTION

A thread battery of the present invention will be described below.

However, the present invention is not limited to the following embodiments, and can be appropriately modified and applied with the modification within the scope without changing the spirit of the present invention. It should be noted that those obtained by combining two or more of individual desirable configurations to be described below are also the present invention.

The thread battery of the present invention includes: a thread-like first electrode that extends in a longitudinal direction between a first end and a second end that face each other in the longitudinal direction; a solid electrolyte on an outer peripheral surface of the first electrode; a second electrode on an outer peripheral surface of the solid electrolyte; a first current collector covering the first end; and a second current collector covering the second end.

In the thread battery of the present invention, at the first end, the first current collector is connected to the first electrode, and is not connected to the second electrode. Moreover, at the second end, the second current collector is connected to the second electrode, and is not connected to the first electrode.

In the thread battery of the present invention, since the first current collector and the second current collector are on opposed ends of the battery, it is easy to connect a conductor to each of the current collectors to draw a current therefrom. Furthermore, a plurality of the thread batteries of the present invention can be disposed and connected in series or in parallel to one another, whereby voltage design can be freely performed.

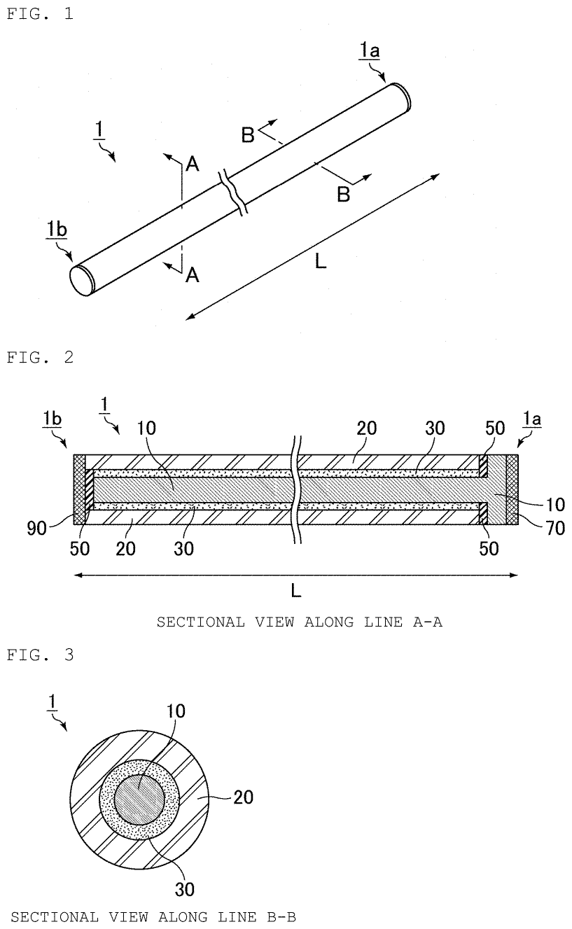

An example of a configuration of the thread battery of the present invention will be described with reference to FIGS. 1, 2 and 3.

FIG. 1 is a perspective view schematically illustrating an example of the thread battery of the present invention, FIG. 2 is a sectional view taken along a line A-A in FIG. 1, and FIG. 3 is a sectional view taken along a line

B-B in FIG. 1.

The thread battery 1 illustrated in FIG. 1 has a first end 1a and a second end 1b which face each other in the longitudinal direction (direction indicated by a double arrow L in FIG. 1).

As illustrated in FIGS. 2 and 3, the thread battery 1 includes a first electrode 10, a solid electrolyte 30, a second electrode 20, a first current collector 70, and a second current collector 90.

The first electrode 10 has a thread shape that extends in the longitudinal direction (direction indicated by the double arrow L in FIG. 2), in which the solid electrolyte 30 is disposed on an outer peripheral surface of the first electrode 10, and the second electrode 20 is disposed on an outer peripheral surface of the solid electrolyte 30.

The first current collector 70 is connected to the first electrode 10 at the first end 1a, and the second current collector 90 is connected to the second electrode 20 at the second end 1b.

On the other hand, an insulating layer 50 is disposed on an end surface of the first electrode 10 on a second end 1b side, and insulates the first electrode 10 and the second current collector 90 from each other. Hence, at the second end 1b of the thread battery 1, the first electrode 10 is not connected to the second current collector 90. Moreover, an insulating layer 50 is disposed on an end surface of the second electrode 20 on a first end 1a side, and insulates the second electrode 20 and the first current collector 70 from each other. Hence, at the first end 1a of the thread battery 1, the second electrode 20 is not connected to the first current collector 70.

Note that, in FIG. 2, the insulating layers 50 are also disposed on both end surfaces of the solid electrolyte 30; however, the end surfaces of the solid electrolyte 30 may be in contact with the first electrode 10 or the second electrode 20.

In the thread battery 1 illustrated in FIG. 2, on the first end 1a side, the first electrode 10 is disposed between the insulating layer 50 and the first current collector 70; however, the insulating layer 50 and the first current collector 70 may be in direct contact with each other. Even if the first electrode 10 is not disposed between the insulating layer 50 and the first current collector 70 on the first end 1a side, the first electrode 10 is connected to the first current collector 70, and the second electrode 20 is insulated from the first current collector 70 by the insulating layer 50.

Moreover, in the thread battery 1 illustrated in FIG. 2, the second current collector 90 is in direct contact with the insulating layer 50 on the second end 1b side; however, the second electrode 20 may be disposed between the second current collector 90 and the insulating layer 50. Even if the second electrode 20 is disposed between the insulating layer 50 and the second current collector 90 on the second end 1b side, the second electrode 20 is connected to the second current collector 90, and the first electrode 10 is insulated from the second current collector 90 by the insulating layer 50.

In the thread battery 1 illustrated in FIG. 2, the insulating layer 50 is not an essential configuration. For example, on the second end 1b side, the first electrode 10 and the second current collector 90 may be insulated from each other by providing a space between the first electrode 10 and the second current collector 90. Likewise, on the first end 1a side, the second electrode 20 and the first electrode 10 may be insulated from each other by providing a space between the second electrode 20 and the first electrode 10. Moreover, the solid electrolyte 30 may be disposed in the portion of the insulating layer 50.

A part of each of the first current collector 70 and the second current collector 90 may be disposed so as to wrap around the outer peripheral surface of the thread battery 1.

However, the first current collector 70 is set in a range that does not come into contact with the second electrode 20, and the second current collector 90 is set in a range that does not come into contact with the first electrode 10.

When the first current collector 70 and the second current collector 90 are disposed so as to wrap around the outer peripheral surface of the thread battery 1, there is an increase a contact area between the first current collector 70 and the first electrode 10 and a contact area between the second current collector 90 and the second electrode 20, and the internal resistance decreases. Moreover, when the first current collector 70 and the second current collector 90 are disposed so as to wrap around the outer peripheral surface of the thread battery 1, peel strength of the current collectors is improved.

In the thread battery of the present invention, at least a part of an outermost peripheral surface thereof may be covered with an insulating film made of an insulating material.

Here, the outermost peripheral surface means an outermost peripheral surface of a structure composed of the first electrode, the second electrode, and the solid electrolyte [however, excluding both end surfaces in the longitudinal direction (that is, regions where the first current collector 70 and the second current collector 90 are provided in FIG. 2)].

When at least a part of the outermost peripheral surface is covered with an insulating film made of an insulating material, the first electrode, the second electrode and the solid electrolyte can be prevented from being damaged or short-circuited by an external impact, vibration or the like.

The thread battery of the present invention preferably has flexibility.

If the thread battery has flexibility, the thread battery can easily follow a shape of the storage space.

Note that, in the present description, the thread battery is determined to have flexibility when not being broken even if being deformed until a radius of curvature thereof becomes 50 mm.

If the thread battery is not broken when the thread battery is disposed along an inner peripheral surface of a ring having an inner diameter of 100 mm, the thread battery is determined not to be broken even if being deformed until the radius of curvature becomes 50 mm, that is, to have flexibility.

A diameter of the thread battery of the present invention is not particularly limited; however, is preferably 0.005 mm to 1 mm.

When the diameter of the thread battery is 0.005 mm to 1 mm, the thread battery has sufficient flexibility, and becomes easy to follow the shape of the storage space.

When the diameter of the thread battery is less than 0.005 mm, the diameter of the thread battery is too small to obtain a sufficient capacity. Moreover, the internal resistance of the thread battery may become too large. On the other hand, when the diameter of the thread battery exceeds 1 mm, the flexibility of the thread battery may decrease.

Note that the diameter of the thread battery can be obtained by measuring diameters from sectional shapes of sections perpendicular to the longitudinal direction of the thread battery at 10 randomly selected spots and by taking an average value therefrom. However, when a sectional shape of the thread battery is not circular, a diameter of each circle corresponding to a projected area obtained from an area of the section is defined as the diameter of the section.

When the above insulating film is formed, a thickness of the insulating film is also included in the diameter of the thread battery.

A length of the thread battery of the present invention in the longitudinal direction is not particularly limited; however, is preferably 1 mm or more.

In the thread battery of the present invention, a ratio of the diameter to the length is not particularly limited; however, [(length)/(diameter)] is preferably 5 or more.

In the thread battery of the present invention, the sectional shape of the section perpendicular to the longitudinal direction is not limited to a circle, and may be an elliptical shape or a polygonal shape.

In the thread battery of the present invention, one of the first electrode and the second electrode serves as a positive electrode, and the other serves as a negative electrode. A description will be given below of an example in which the first electrode is a positive electrode and the second electrode is a negative electrode.

### First Electrode

The first electrode is composed of a sintered body containing positive electrode active material particles.

Examples of a material that constitutes the positive electrode active material particles include oxides such as a lithium-containing phosphoric acid compound having a NASICON-type structure, a lithium-containing phosphoric acid compound having an olivine-type structure, a lithium-containing layered oxide, and a lithium-containing oxide having a spinel-type structure.

Specific examples of a lithium-containing phosphoric acid compound that has a NASICON-type structure and is to be preferably used include Li₃V₂(PO₄)₃, and the like. Specific examples of a lithium-containing phosphoric acid compound that has an olivine-type structure and is to be preferably used include LiFePO₄, LiCoPO₄, LiMnPO₄, and the like. Specific examples of a preferably used lithium-containing layered oxide include LiCoO₂, LiCo_{1/3}Ni_{1/3}/Mn_{1/3}O₂, and the like. Specific examples of a lithium-containing oxide that has a spinel-type structure and is to be preferably used include LiMn₂O₄, LiNi_{0.5}Mn_{1.5}O₄, and the like.

Only one of these positive electrode active material particles may be used, or a plurality of types thereof may be mixed and used.

Among them, Li₃V₂(PO₄)₃ is particularly preferable.

The first electrode may contain solid electrolyte particles and conductive particles in addition to the positive electrode active material particles.

Examples of a material that constitutes the solid electrolyte particles include oxides which constitute the solid electrolyte to be described later.

The solid electrolyte particles are preferably the same as the oxides which constitute the solid electrolyte to be described later.

When the first electrode contains the solid electrolyte particles, and the solid electrolyte particles are the same as the oxides which constitute the solid electrolyte, then bonding between the first electrode and the solid electrolyte becomes strong, and a response rate and mechanical strength thereof are improved.

Examples of the conductive particles include particles composed of a metal such as Ag, Au, Pt and Pd, carbon, a compound having electron conductivity, a mixture obtained by combining these, and the like. Moreover, these substances having conductivity may be contained in the first electrode in a state of being coated on the surfaces of the positive electrode active material particles.

### Second Electrode

The second electrode is composed of a sintered body containing negative electrode active material particles.

Examples of a material that constitutes the negative electrode active material particles include a compound represented by MO_{X} (M is at least one selected from the group consisting of Ti, Si, Sn, Cr, Fe, Nb, V and Mo. 0.9≤X≤3.0), a compound represented by Li_{Y}MO_{X} (M is at least one selected from the group consisting of Ti, Si, Sn, Cr, Fe, Nb, V and Mo. 0.9≤X≤3.0, 2.0≤Y≤4.0), a graphite-lithium compound, a lithium alloy, a lithium-containing phosphoric acid compound having a NASICON-type structure, a lithium-containing phosphoric acid compound having an olivine-type structure, a lithium-containing oxide having a spinel-type structure, and the like, and the material is preferably an oxide such as the compound represented by MOₓ, the compound represented by Li_{Y}MO_{X}, the lithium-containing phosphoric acid compound having a NASICON-type structure, the lithium-containing phosphoric acid compound having an olivine-type structure, and the lithium-containing oxide having a spinel-type structure.

The compound represented by MO_{X} may have a part of oxygen substituted with P or Si, or may contain Li. Specific examples of the lithium alloy to be preferably used include Li—Al and the like. Specific examples of the lithium-containing phosphoric acid compound that has a

NASICON-type structure and is to be preferably used include Li₃V₂(PO₄)₃, Li₃Fe₂(PO₄)₃, and the like. Specific examples of the lithium-containing oxide that has a spinel-type structure and is to be preferably used include Li₄Ti₅O₁₂ and the like. Only one of these negative electrode active material particles may be used, or a plurality of types thereof may be mixed and used.

Among them, Li₃V₂(PO₄)₃ is particularly preferable.

The second electrode may contain solid electrolyte particles and conductive particles in addition to the negative electrode active material particles.

Examples of a material that constitutes the solid electrolyte particles include oxides which constitute the solid electrolyte to be described later.

The solid electrolyte particles are preferably the same as the oxides which constitute the solid electrolyte to be described later.

When the second electrode contains the solid electrolyte particles, and the solid electrolyte particles are the same as the oxides which constitute the solid electrolyte, then bonding between the second electrode and the solid electrolyte becomes strong, and a response rate and mechanical strength thereof are improved.

Examples of those to be preferably used as the conductive particles include particles composed of a metal such as Ag, Au, Pt and Pd, carbon, a compound having electron conductivity, a mixture obtained by combining these, or the like. Moreover, these substances having conductivity may be contained in the second electrode in a state of being coated on the surfaces of the negative electrode active material particles or the like.

Note that, in the present description, the oxide does not include sulfide oxide.

### Solid Electrolyte

Examples of the solid electrolyte include oxides such as a lithium-containing phosphoric acid compound having a NASICON-type structure.

Examples of a lithium-containing phosphoric acid compound that has a NASICON-type structure and is to be preferably used include LiₓM_{y}(PO₄)₃ (0.9≤x≤1.9, 1.9≤y≤2.1, and M is at least one selected from the group consisting of Ti, Ge, Al, Ga and Zr).

As the lithium-containing phosphoric acid compound, Li_{1.2}Al_{0.2}Ti_{1.8}(PO₄)₃ is preferable.

Lithium-containing phosphoric acid compounds having two or more types of NASICON-type structures having different compositions may be mixed and used.

Examples of a preferred composition of the solid electrolyte include: a vitrifiable composition represented by Liᵢ₊ₓAlₓGe₂₋ₓ(PO₄)₃ [for example, Li_{1.5}Al_{0.5}Ge_{1.5}(PO₄)₃, Li_{1.2}Al_{0.2}Ge_{1.8}(PO₄)₃, and the like], a vitrifiable composition represented by Li₁₊ₓAlₓGe_{2-x-y}Ti_{y}(PO₄)₃ [for example, Li_{1.5}Al_{0.5}Ge_{1.0}Ti_{0.5}(PO₄)₃, Li_{1.2}Al_{0.2}Ge_{1.3}Ti_{0.5}(PO₄)₃, and the like], a mixture of at least one selected from the group consisting of AlPO₄, SiO₂ and B₂O₃ and Li₁₊ₓAlₓGe₂₋ₓ (PO₄)₃ or Li₁₊ₓAlₓGe_{2-x-y}Ti_{y} (PO₄)₃, a mixture of Li₁₊ₓAlₓGe₂₋ₓ (PO₄)₃ and Li₁₊ₓAlₓGe_{2-x-y}Ti_{y} (PO₄)₃, the one in which a part of Li of Li₁₊ₓAlₓGe₂₋ₓ (PO₄)₃ or Li₁₊ₓAlₓGe_{2-x-y}Ti_{y} (PO₄)₃ is replaced by Na, Co, Mn or Ni [for example, Li_{1.1}Na_{0.1}Al_{0.2}Ge_{1.3}Ti_{0.5}(PO₄)₃, Li_{1.4}Na_{0.1}Al_{0.5}Ge_{1.0}Ti_{0.5}(PO₄)₃, and the like, in each of which a part of Li is replaced by Na], and the one in which a part of Ge of Liᵢ₊ₓAlₓGe₂₋ₓ (PO₄)₃ or Li₁₊ₓAlₓGe_{2-x-y}Ti_{y} (PO₄)₃ is replaced by Zr, Fe or V [for example, Li_{1.2}Al_{0.2}Ge_{1.7}Zr_{0.1} (PO₄)₃, Li_{1.5}Al_{0.5}Ge_{1.0}Ti_{0.4}Zr_{0.1}(PO₄)₃, and the like, in each of which a part of Ge is replaced by Zr]. Two or more of these may be mixed and used.

In addition to the lithium-containing phosphoric acid compound having a NASICON-type structure, the solid electrolyte may further contain an oxide solid electrolyte having a perovskite-type structure or an oxide solid electrolyte having a garnet-type or garnet-like structure. Specific examples of the oxide solid electrolyte having a perovskite-type structure include La_{0.55}Li_{0.35}TiO₃, and specific examples of the oxide solid electrolyte having a garnet-type or garnet-like structure include, for example, Li₇La₃Zr₂O₁₂.

In the thread battery of the present invention, preferably, the first electrode, the second electrode, and the solid electrolyte all contain oxides.

When the first electrode, the second electrode, and the solid electrolyte all contain oxides, it becomes easy to form a sintered body. Moreover, even if the sintered body containing an oxide is fractured by being applied with a stress, continuous breakdown starting from each fractured fragment is unlikely to occur, and accordingly, the sintered body is less likely to shatter, a short circuit thereof is prevented, and a function of the battery is maintained.

In the thread battery of the present invention, preferably, at least one of the first electrode and the second electrode contains the same oxide as that of the solid electrolyte, and more preferably, both the first electrode and the second electrode contain the same oxide as that of the solid electrolyte. In particular, preferably, at least one of the first electrode and the second electrode contains such a lithium-containing phosphoric acid compound as Li_{1.2}Al_{0.2}Ti_{1.8}(PO₄)₃, and more preferably, both the first electrode and the second electrode contain the above lithium-containing phosphoric acid compound.

An electrode containing the same oxide as that of the solid electrolyte has a strong bond with the solid electrolyte, and accordingly, a response rate and mechanical strength thereof are improved.

In the thread battery of the present invention, preferably, the first electrode, the second electrode and the solid electrolyte do not substantially contain a sulfide or a sulfide oxide.

When the first electrode contains the same oxide as that of the solid electrolyte, a content thereof is preferably 30% by weight to 70% by weight.

If the content of the oxide in the first electrode is less than 30% by weight, then bonding strength between the first electrode and the solid electrolyte may not be sufficiently improved. On the other hand, if the content exceeds 70% by weight, then a ratio of the positive electrode active material particles in the first electrode decreases, and accordingly, an energy density may decrease.

Note that the content of the oxide in the first electrode can be measured by composition analysis such as inductively coupled plasma (ICP) emission spectroscopy.

Moreover, for simplicity, data analysis such as powder X-ray diffraction (XRD) can also be used.

When the second electrode contains the same oxide as that of the solid electrolyte, a content thereof is preferably 30% by weight to 70% by weight.

If the content of the oxide in the second electrode is less than 30% by weight, then bonding strength between the second electrode and the solid electrolyte may not be sufficiently improved. On the other hand, if the content exceeds 70% by weight, then a ratio of the negative electrode active material particles in the second electrode decreases, and accordingly, the energy density may decrease.

Note that the oxide content in the second electrode can be measured in a similar manner to that in the first electrode.

### Current Collector

The first current collector and the second current collector will be described.

When the first electrode is a positive electrode, the first current collector is a positive electrode current collector, and when the second electrode is a negative electrode, the second current collector is a negative electrode current collector.

The positive electrode current collector and the negative electrode current collector are not particularly limited as long as having electron conductivity. The positive electrode current collector and the negative electrode current collector can be composed of, for example, carbon, an oxide and a composite oxide which have high electron conductivity, a metal, or the like. For example, the positive electrode current collector and the negative electrode current collector can be composed of Pt, Au, Ag, Al, Cu, stainless steel, indium tin oxide (ITO), or the like.

Ni or Al is preferable as such a material that constitutes the positive electrode current collector. On the other hand, Cu is preferable as such a material that constitutes the negative electrode current collector.

### Insulating Layer

A material that constitutes the insulating layer is only required to be an insulating material, and examples thereof include glass, ceramics, and an insulating resin.

Examples of the glass include quartz glass (SiO₂), composite oxide-based glass obtained by combining at least two selected from the group consisting of SiO₂, PbO, B₂O₃, MgO, ZnO, Bi₂O₃, Na₂O and Al₂O₃, and the like.

Examples of the ceramics include alumina, cordierite, mullite, steatite, forsterite, and the like.

Examples of the insulating resin include:

thermoplastic resin such as polyethylene, polypropylene, polyvinyl chloride, polystyrene, polyvinyl acetate, thermoplastic polyurethane, and Teflon (registered trademark); thermosetting resin such as phenol resin, epoxy resin, melamine resin, urea resin, unsaturated polyester resin, alkyd resin, polyurethane, and thermosetting polyimide; photocurable resin; and the like.

A thickness of the insulating layer (that is, a length of the thread battery in the longitudinal direction) is not particularly limited; however, is preferably 0.005 mm or more and 1 mm or less.

### Insulating Film

A material that constitutes the insulating film is only required to be an insulating material, and for example, a material similar to the insulating material that constitutes the insulating layer can be suitably used.

A thickness of the insulating film is not particularly limited; however, is preferably 0.005 mm or more and 1 mm or less.

### Manufacturing Method

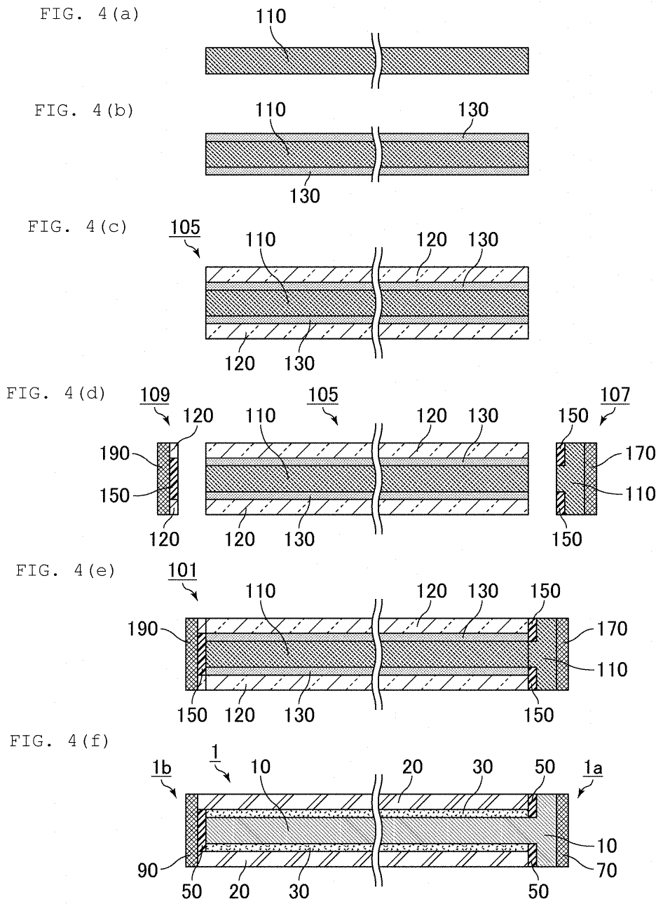

An example of a method for manufacturing the thread battery of the present invention will be described with reference to FIGS. 4(a) to 4(f).

FIGS. 4(a) to 4(f) are schematic views illustrating the example of the method for manufacturing the thread battery of the present invention.

As illustrated in FIG. 4(a), first, a first electrode precursor 110 that serves as the first electrode 10 is molded into a thread shape.

Examples of a method for molding a first electrode precursor 110 into a thread shape include a method of spinning a mixed solution containing a material that constitutes the first electrode, an organic binder, and a dispersion medium.

As a method of spinning the above mixed solution, a general spinning method can be used.

Note that, instead of the step illustrated in FIG. 4(a), the first electrode 10 itself may be fabricated.

Examples of a method for fabricating the first electrode 10 itself include a method of melting and spinning a material that constitutes the first electrode 10.

Subsequently, as illustrated in FIG. 4(b), a solid electrolyte precursor 130 that serves as the solid electrolyte 30 is formed on an outer peripheral surface of the first electrode precursor 110.

Examples of a method for forming the solid electrolyte precursor 130 on the outer peripheral surface of the first electrode precursor 110 include a method of applying slurry, which is obtained by mixing the material that constitutes the solid electrolyte 30 and the dispersion medium with each other, to the outer peripheral surface of the first electrode precursor 110, followed by drying.

An organic binder may be added to the slurry according to needs.

Subsequently, as illustrated in FIG. 4(c), a second electrode precursor 120 that serves as the second electrode 20 is formed on an outer peripheral surface of the solid electrolyte precursor 130.

Examples of a method for forming the second electrode precursor 120 on the outer peripheral surface of the solid electrolyte precursor 130 include a method of applying slurry, which is obtained by mixing the material that constitutes the second electrode 20 and the dispersion medium with each other, to the outer peripheral surface of the solid electrolyte precursor 130.

An organic binder may be added to the slurry according to needs.

According to FIGS. 4(a) to 4(c), in a portion that serves as the thread battery 1, a main body structure 105 that is a portion other than the first end 1a and the second end 1b is prepared.

Subsequently, as illustrated in FIG. 4(d), on one end of the main body structure 105, a first end structure 107 composed of a first current collector precursor 170, the first electrode precursor 110 and an insulating layer precursor 150 is disposed, and on the other end thereof, a second end structure 109 composed of a second current collector precursor 190, the second electrode precursor 120 and an insulating layer precursor 150 is disposed.

At this time, on a surface of the first end structure 107, which is to be bonded to the main body structure 105, preferably, the first electrode precursor 110 is disposed at a portion thereof that comes into contact with the first electrode precursor 110 of the main body structure 105, the insulating layer precursor 150 is disposed at a portion thereof that comes into contact with the solid electrolyte precursor 130 of the main body structure 105, and the insulating layer precursor 150 is disposed at a portion thereof that comes into contact with the second electrode precursor 120 of the main body structure 105. However, the first electrode precursor 110 may be disposed at the portion that comes into contact with the solid electrolyte precursor 130 of the main body structure 105.

Moreover, on a surface of the second end structure 109, which is to be bonded to the main body structure 105, preferably, the insulating layer precursor 150 is disposed at a portion thereof that comes into contact with the first electrode precursor 110 of the main body structure 105, the insulating layer precursor 150 is disposed at a portion thereof that comes into contact with the solid electrolyte precursor 130 of the main body structure 105, and the second electrode precursor 120 is disposed at a portion thereof that comes into contact with the second electrode precursor 120 of the main body structure 105. However, the second electrode precursor 120 may be disposed at the portion that comes into contact with the solid electrolyte precursor 130 of the main body structure 105.

Examples of a method for fabricating the first end structure 107 include a method of forming the first electrode precursor 110 and the insulating layer precursor 150 on the surface of the first current collector precursor 170.

Examples of the method for forming the first electrode precursor 110 and the insulating layer precursor 150 on the surface of the first current collector precursor 170 include a method of applying, onto a substrate, a mixed solution containing the material that constitutes the first current collector, an organic binder and a dispersion medium, drying the mixed solution, thereby obtaining a sheet-shaped first current collector precursor, thereafter applying a mixed solution, which contains the material that constitutes the first electrode, an organic binder and a dispersion medium, and slurry, which is obtained by mixing the insulating material that constitutes the insulating layer and a dispersion medium with each other, to a surface of the sheet-shaped first current collector precursor by a method such as an inkjet method and screen printing, followed by drying, and the like.

Examples of a method for fabricating the second end structure 109 include a method of forming the insulating layer precursor 150 and the second electrode precursor 120 on the surface of the second current collector precursor 190. As a method for forming the second electrode precursor 120 and the insulating layer precursor 150 on the surface of the second current collector precursor 190, a similar method to the method of fabricating the first end structure 107 can be used.

As illustrated in FIG. 4(e), the main body structure 105, the first end structure 107, and the second end structure 109 are bonded to one another to fabricate a thread battery precursor 101, followed by firing, whereby the thread battery 1 illustrated in FIG. 4(f) is obtained.

Firing conditions are not particularly limited; however, are preferably 500° C. or higher and 1000° C. or lower.

A firing atmosphere is not particularly limited as long as the respective materials are stably synthesized and sintered.

By the above procedure, the thread battery of the present invention can be manufactured.

On the surface of the obtained thread battery, according to needs, a mixed solution obtained by mixing an insulating material and a solvent with each other may be applied and then dried, whereby an insulating film composed of an insulating material may be formed.

### DESCRIPTION OF REFERENCE SYMBOLS

1: Thread battery

1a: First end

1b: Second end

10: First electrode

20: Second electrode

30: Solid electrolyte

50: Insulating layer

70: First current collector

90: Second current collector

101: Thread battery precursor

105: Main body structure

107: First end structure

109: Second end structure

110: First electrode precursor

120: Second electrode precursor

130: Solid electrolyte precursor

150: Insulating layer precursor

170: First current collector precursor

190: Second current collector precursor

1. A thread battery comprising:
a thread-like first electrode that extends in a longitudinal direction between a first end and a second end that face each other in the longitudinal direction;
a solid electrolyte on an outer peripheral surface of the first electrode;
a second electrode on an outer peripheral surface of the solid electrolyte;
a first current collector covering the first end, connected to the thread-like first electrode, and not connected to the second electrode; and
a second current collector covering the second end, connected to the second electrode, and not connected to the first electrode.

2. The thread battery according to claim 1, wherein the first electrode, the second electrode, and the solid electrolyte all contain oxides.

3. The thread battery according to claim 2, wherein the oxides are selected from a lithium-containing phosphoric acid compound having a NASICON-type structure, an oxide solid electrolyte having a perovskite-type structure, and an oxide solid electrolyte having a garnet-type or garnet-like structure.

4. The thread battery according to claim 2, wherein at least one of the first electrode and the second electrode contains a same oxide as contained in the solid electrolyte.

5. The thread battery according to claim 4, wherein the same oxide is selected from a lithium-containing phosphoric acid compound having a NASICON-type structure, an oxide solid electrolyte having a perovskite-type structure, and an oxide solid electrolyte having a garnet-type or garnet-like structure.

6. The thread battery according to claim 4, wherein a content of the same oxide in the at least one of the first electrode and the second electrode is 30% by weight to 70% by weight.

7. The thread battery according to claim 2, wherein each of the first electrode and the second electrode contain a same oxide as contained in the solid electrolyte.

8. The thread battery according to claim 7, wherein the same oxide is selected from a lithium-containing phosphoric acid compound having a NASICON-type structure, an oxide solid electrolyte having a perovskite-type structure, and an oxide solid electrolyte having a garnet-type or garnet-like structure.

9. The thread battery according to claim 7, wherein a content of the same oxide in each of the first electrode and the second electrode is 30% by weight to 70% by weight.

10. The thread battery according to claim 1, further comprising an insulating layer on the first end surface and between the first current collector and the second electrode.

11. The thread battery according to claim 1, further comprising an insulating layer on the second end surface and between the second current collector and the first electrode.

12. The thread battery according to claim 1, further comprising:
a first insulating layer on the first end surface and between the first current collector and the second electrode; and
a second insulating layer on the second end surface and between the second current collector and the first electrode.

13. The thread battery according to claim 1, wherein a diameter of the thread battery is 0.005 mm to 1 mm.

14. The thread battery according to claim 1, wherein a ratio of a diameter to a length of the thread battery is 5 or more.

15. The thread battery according to claim 1, wherein the thread battery has a circular sectional shape.
